(19) United States
(12) Patent Application Publication
(10) Pub. No.: US 2008/0231408 A1
(43) Pub. Date: Sep. 25, 2008

(54) Transformer

(75) Inventor: Feng Jin Wang, Shenzhen (CN)

Correspondence Address: GLOBAL IP SERVICES, 7285 W. Eagle Court, Winton, CA, 95388, US

(73) Assignee: Shenzhen Putly Optic-Electronic Technology Co., Ltd., Shenzhen (CN)

(21) Appl. No.: 12/051,719

(22) Filed: Mar. 19, 2008

(30) Foreign Application Priority Data
Mar. 23, 2007 (CN) 200710073653.2

(51) Int. Cl. H01F 27/24; H01F 27/28

(52) U.S. Cl. 336/212; 336/200

(57) ABSTRACT

The present invention provides a transformer including a plurality of magnetic circuits comprised of a plurality of magnetic cores and a coil winding around said magnetic circuits, wherein said coil winding is one or any combination of a coil winding, a planar conductor winding, and an equivalent winding made up of printed circuit boards. The present invention makes different combination of a planar conductor winding, a coil winding, and an equivalent winding made up of printed circuit boards based on actual needs to realize input and output requirements of different current and voltage. Said magnetic circuits disperse heat spots, improve environment of heat dissipation, and enhance output power of said transformer.

### CROSS-REFERENCE TO RELATED APPLICATION

This application claims the priority of Chinese Application Serial No. CN200710073653.2, filed Mar. 23, 2007, the entire contents of which are incorporated herein by reference.

### BACKGROUND OF THE INVENTION

1. Field of the Invention

The present invention relates to the field of transformer, especially relates to a kind of transformer.

2. Description of the Related Art

Transformer is a part of an apparatus, which is used to transform alternative voltage, current and impedance. The transformer is composed of magnetic core and coil winding, and said coil winding include two or more windings. The magnetic core and the windings are called main body of a transformer, which is used to set up magnetic field and transmit electricity. The magnetic core forms the magnetic circuit of the transformer in principle, which change the electric power energy of primary circuit into the magnetic energy, and then transfer the magnetic energy into the electric power energy of secondary circuit, therefore, the magnetic core is the medium of energy transmission. The magnetic core forms the framework of a transformer structurally. The insulating coil windings cover the magnetic core column, supporting and packing hard. The transformer in existence belongs to single magnetic circuit basically. It has disadvantages of complex structure, large volume, difficult heat dissipation, and great loss, so it is difficult to satisfy the input and output requirements of different current and voltage.

### SUMMARY OF THE INVENTION

One object of the present invention is to provide a transformer, change single magnetic circuit of a transformer in existence, and solve the problems of complex structure, large volume, difficult heat dissipation, great loss, and input and output requirements of different current and voltage.

To achieve this object, the present invention provides a transformer including a plurality of magnetic circuits comprised of a plurality of magnetic cores and a coil winding around said magnetic circuits, wherein said coil winding is one or any combination of a coil winding, a planar conductor winding, and an equivalent winding made up of printed circuit boards.

To achieve the object, the present invention provides another transformer including a plurality of magnetic circuits comprised of a plurality of magnetic cores and a coil winding around said magnetic circuits, wherein said magnetic core is selected from the group consisting of U shaped magnetic core, CD iron core, magnetic core with round core column, and magnetic core with central column.

To achieve the object, the present invention further provides a transformer including a plurality of magnetic circuits comprised of a plurality of magnetic cores and a coil winding around said magnetic circuits, wherein said coil winding is one or any combination of a coil winding, a planar conductor winding, and an equivalent winding made up of printed circuit boards, said magnetic core is selected from the group consisting of U shaped magnetic core, CD iron core, magnetic core with round core column, and magnetic core with central column.

The present invention combines planar conductor winding, coil winding, and equivalent winding made up of printed circuit boards to realize input and output requirements of different current and voltage. Multiple magnetic circuit disperse heat spots, improve environment of heat dissipation, and enhance output power of a transformer.

### BRIEF DESCRIPTION OF THE DRAWINGS

FIG. 1 and FIG. 2 are schematic diagrams of coil winding.

FIG. 3 and FIG. 4 are schematic diagrams of planar conductor winding.

FIG. 5 and FIG. 6 are schematic diagrams of equivalent winding made up of printed circuit boards.

FIG. 7 is a schematic diagram of a transformer combined coil winding and planar conductor winding.

FIG. 8 is a schematic diagram of a transformer combined planar conductor winding and equivalent winding made up of printed circuit boards, which is suitable for the application of PFC.

FIG. 9 is a schematic diagram of a transformer combined planar conductor winding and equivalent winding made up of printed circuit boards, which is suitable for PC source.

FIG. 10 is a schematic diagram of a transformer using U shaped magnetic core and CD iron core.

FIG. 11 is a schematic diagram of a transformer using magnetic core with round core column.

FIG. 12 is a schematic diagram of a transformer using magnetic core with central column.

### DETAILED DESCRIPTION OF THE INVENTION

For the purpose of understanding the present invention clearly and easily, the embodiment of a transformer in present invention will be further described combining with schematic diagrams. The description of the embodiment mentioned here can only explain the present invention, but not determine the limited range of the claim.

The embodiment of the present invention make different combination based on actual needs. It combines planar conductor winding, coil winding, and equivalent winding made up of printed circuit boards to realize input and output requirements of different current and voltage.

The coil winding composing transformer in embodiment of the present invention is coil winding, planar conductor winding, and equivalent winding made up of printed circuit boards, and it is possible to produce transformer by combining any of coil windings to satisfy demonds in different applications.

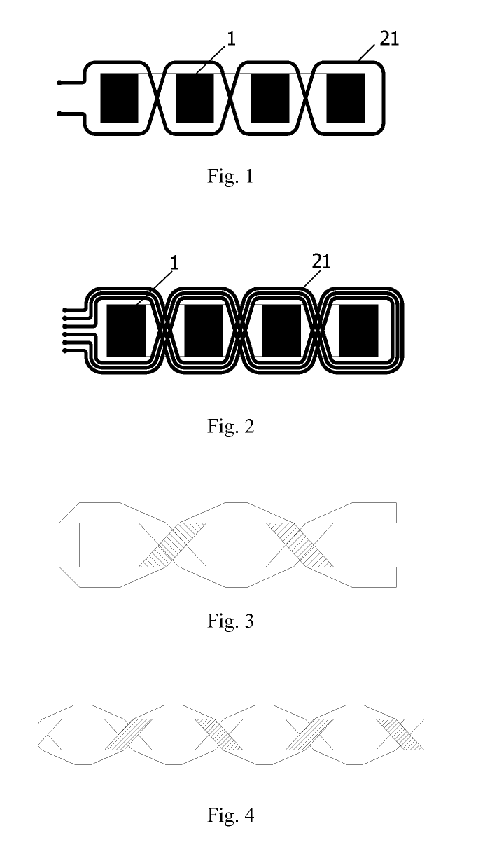

The coil winding 21 is formed by wires, which interwind a plurality of magnetic cores 1 successively and surround a plurality of magnetic circuits respectively in vertical direction of said magnetic circuit. Said wire is single lead or multiple leads side by side in vertical direction of said magnetic circuits shown in FIG. 1 and FIG. 2, and said coil winding is full turn or half turn. Said wire is enameled wire or flat conductive plate, and said wire is enwinded with standard copper, aluminum and other wires, or various conductive foil, such as copper foil, aluminum foil and so on. Said enameled wire is circular enameled wire, but flat enameled wire is the best when produce a plurality of coil windings.

The planar conductor winding 22 is produced by folding thin conductor materials shown in FIG. 3 and FIG. 4. Said planar conductor winding is made up of thin conductor materials, such as copper, aluminum, and closed winding folded by bending S-shaped conductor which is formed by folding thin conductor materials.

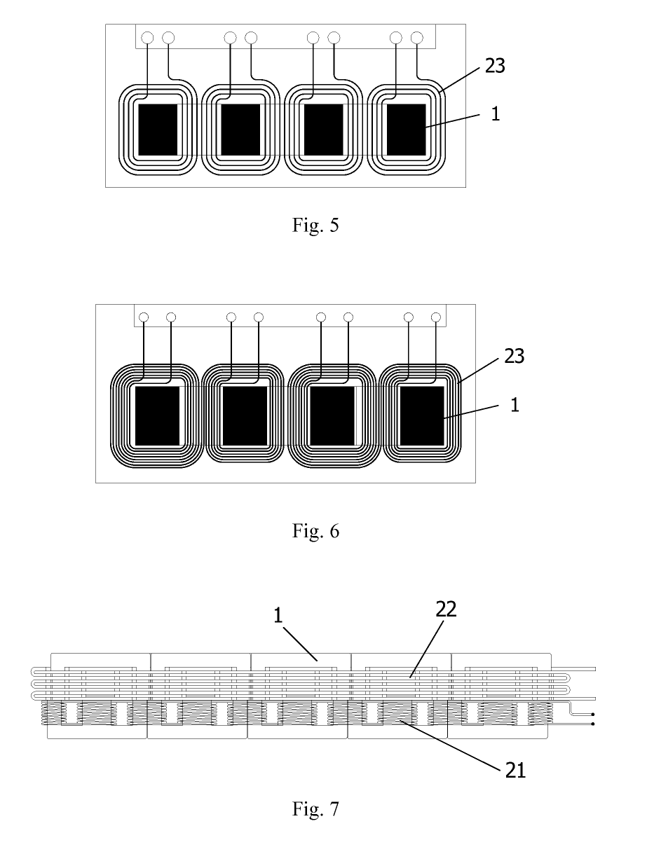

The equivalent winding 23 is made up of printed circuit boards which is single layer or multiple layer. Said equivalent winding can be independently used in each magnetic circuit of a transformer, or shared with many magnetic circuits shown in FIG. 5 and FIG. 6. Said equivalent winding is full turn or half turn, and series or parallel equivalent winding around each magnetic circuit is available based on demand of voltage transformation. Therefore, voltage transformation ratio is changed according to the requirement, and the application range of a transformer is wider.

The transformer combined coil winding 21 and planar conductor winding 22 in embodiment of the present invention is shown in FIG. 7. Said coil winding is suitable for high voltage application, and said planar conductor winding applies in the situation of low voltage and high current.

It can be realized in the application of power distribution, such as 10 KV/0.4 KV, the application of high current output, such as electrolysis, electric welding, and electroplating through input coil winding and output planar conductor winding.

The situation of high voltage output, such as duster applied in environmental protection and other high voltage output products can be realized through input planar conductor winding and output coil winding.

At present, it has been realized in the application of 50 KW single phase transformer with input 10 KV and output 380V, 20 KW precipitation power with output 20 KV, and the coil winding with high voltage trigger used in gas discharge lamp with input 80V and output 4 KV pulse using the structure in graph.

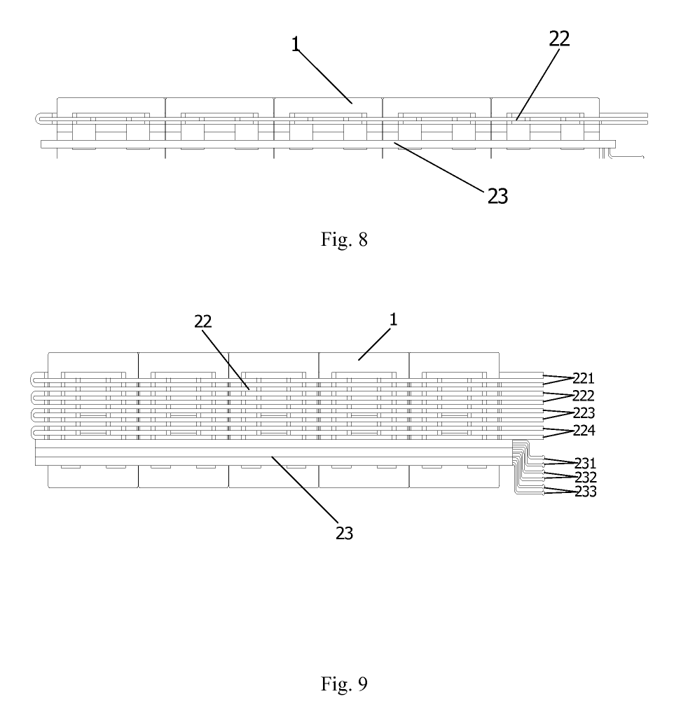

The transformer combined planar conductor winding 22 and equivalent winding made up of printed circuit boards 23 in embodiment of the present invention is shown in FIG. 8, which applies to PFC (Power Factor Correction, PFC).

The entirely controlled circuit applied in PFC has been realized on the application of said equivalent winding made up of printed circuit boards, meanwhile, said equivalent winding made up of printed circuit boards can provide auxiliary output voltage to other circuits. The circuit index of standard PFC inductance used in said planar conductor winding is as follows: the input power can reach 5000 W, the efficiency is 94%, and the inductance of PFC is 400UH.

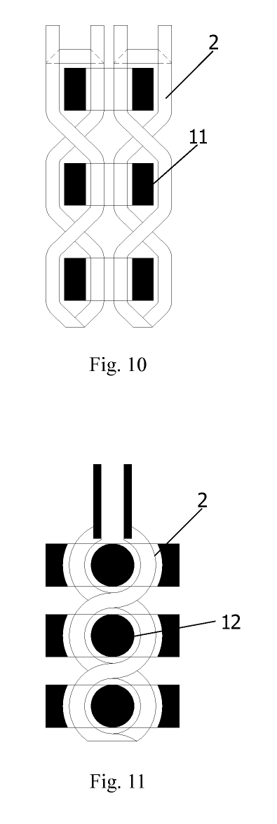

The transformer suitable for PC source combined planar conductor winding 22 and equivalent winding made up of printed circuit boards 23 in the embodiment of the present invention is shown in FIG. 9, which contains an input unit 221, an output unit with 12V 222, 223, an output unit with 5V 224, an output unit with −5V 231, an output unit with −12V 232, and a standard standby power 233. The whole power sources accord with ATX2.2 standard, and the efficiency is about 90%.

Said planar conductor winding in the present embodiment realized input winding for PC source and output winding with high current for PC source. Said equivalent winding made up of printed circuit boards can provide auxiliary output with small current in need of PC source, and the control of all the input and output units is implemented on said equivalent winding made up of printed circuit boards.

The input control used active clamped forward converter, and the way of output control is synchronous rectifier.

The transformer made up of two planar conductor windings on input and output terminal is available in present embodiment, which is suitable for small potential difference and high current output. At present, 500 KW industrial frequency transformer and 100 KW high frequency transformer have been implemented with this method.

The transformer can make different combination based on actual needs besides the combination above, such as combined coil winding and equivalent winding made up of printed circuit boards, combined coil winding, planar conductor winding and equivalent winding made up of printed circuit boards, single coil winding, single planar conductor winding, and single equivalent winding made up of printed circuit boards.

It is possible to produce transformer using magnetic core with different shapes to satisfy demands in different applications as a preferred embodiment of present invention.

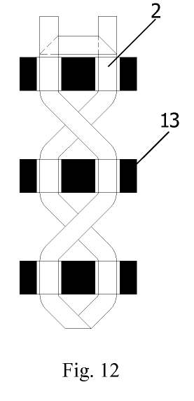

The transformer using U shaped magnetic core and CD iron core in embodiment of present invention is shown in FIG. 10, which adopt 8 pairs of UU160 magnetic cores 11 and realize output with 40 KW, frequency with 40 KHz and efficiency of the transformer with 98%.

The transformer using magnetic core with round core column 12 and round winding in embodiment of present invention is shown in FIG. 11, which applies in transformer, such as EC, ETD, PQ, and RM.

The transformer using magnetic core with central column 13 in embodiment of present invention is shown in FIG. 12, which the cross section of said central column is rectangular or other shapes.

The present invention combines planar conductor winding, coil winding, and equivalent winding made up of printed circuit boards to realize input and output requirements with different current and voltage. Multiple magnetic circuit disperse heat spots, improve environment of heat dissipation, and enhance output power of the transformer, meanwhile, transformer using magnetic core with different shapes satisfies demands in different applications.

These description mentioned above is the optimization embodiment, and it is impossible to determine the limited range of the claim by this, therefore, the equate changes based on the patent application scope in present invention still belong to the scope of patent protection inpresent invention.

What is the claimed is:

1. A transformer, comprising:
a plurality of magnetic circuits formed by a plurality of magnetic cores; and
a coil winding around said magnetic circuits;
wherein said coil winding is one or any combination of a coil winding, a planar conductor winding, and an equivalent winding made up of printed circuit boards.

2. The transformer of claim 1, wherein said coil winding is formed by wires which interwind said magnetic cores successively and surround said magnetic circuits respectively in the vertical direction of said magnetic circuit.

3. The transformer of claim 1, wherein said planar conductor winding is a closed winding folded by bending S-shaped conductor which is formed by folding thin conductor material.

4. The transformer of claims 1, wherein said magnetic core is selected from the group consisting of U shaped magnetic core, CD iron core, magnetic core with round core column, and magnetic core with central column.

5. The transformer of claims 2, wherein said magnetic core is selected from the group consisting of U shaped magnetic core, CD iron core, magnetic core with round core column, and magnetic core with central column.

6. The transformer of claims 3, wherein said magnetic core is selected from the group consisting of U shaped magnetic core, CD iron core, magnetic core with round core column, and magnetic core with central column.

7. A transformer, comprising:
a plurality of magnetic circuits formed by a plurality of magnetic cores; and
a coil winding around said magnetic circuits;
wherein said magnetic core is selected from the group consisting of U shaped magnetic core, CD iron core, magnetic core with round core column, and magnetic core with central column.

8. The transformer of claim 7, wherein said coil winding is one or any combination of a coil winding, a planar conductor winding, and an equivalent winding made up of printed circuit boards.

9. The transformer of claim 8, wherein said coil winding is formed by wires, which interwind said magnetic cores successively and surround said magnetic circuits respectively in the vertical direction of said magnetic circuit.

10. The transformer of claim 8, wherein said planar conductor winding is a closed winding folded by bending S-shaped conductor which is formed by folding thin conductor material.

11. A transformer, comprising:
a plurality of magnetic circuits formed by a plurality of magnetic cores; and
a coil winding around said magnetic circuits;
wherein said coil winding is one or any combination of a coil winding, a planar conductor winding, and an equivalent winding made up of printed circuit boards;
said magnetic core is selected from the group consisting of U shaped magnetic core, CD iron core, magnetic core with round core column, and magnetic core with central column.
